(19) United States
(12) Patent Application Publication
(10) Pub. No.: US 2012/0077669 A1
(43) Pub. Date: Mar. 29, 2012

(54) Polymer-Assisted Synthesis Of A Supported Metal Catalyst

(75) Inventors: Torsten Müller-Stach, Hannover (DE); Attilio Siani, Hannover (DE); Torsten Neubauer, Langenhagen (DE); Xinyi Wei, Princeton, NJ (US)

(73) Assignees: BASF Corporation, Florham Park, NJ (US); BASF SE, Ludwigshafen (DE)

(21) Appl. No.: 13/247,069

(22) Filed: Sep. 28, 2011

Related U.S. Application Data
(60) Provisional application No. 61/387,482, filed on Sep. 29, 2010.

(51) Int. Cl. B01J 31/06; B01D 53/86; F01N 3/10; B01D 53/94

(52) U.S. Cl. 502/159; 423/212; 423/210; 60/299

(57) ABSTRACT

Described is a process for the preparation of a catalyst comprising the steps of:
(i) providing one or more support materials;
(ii) providing one or more polymers on the support material; and
(iii) providing one or more metals on the one or more supported polymers; wherein in step (ii) the one or more polymers do not comprise cross-linked polymers and/or polymers which have been reacted with a cross-linking agent. Also described is a catalyst obtained or obtainable according to said process, as well as the use of the catalyst, in particular in a method for the treatment of automobile engine exhaust gas.

### CROSS-REFERENCE TO RELATED APPLICATIONS

This application claims priority under 35 U.S.C. §119(e) to United States Provisional Application No. 61/387,482, filed Sep. 29, 2010, the disclosure of which is incorporated herein by reference in its entirety.

### TECHNICAL FIELD

The present invention relates to a process for the preparation of a catalyst comprising a metal provided on a support material, as well as to a catalyst which is obtained or obtainable according to said process and to its use in a method for the purification of exhaust gas.

### BACKGROUND

Exhaust gas emitted from an internal combustion engine such as an automobile engine contains carbon monoxide (CO), hydrocarbons (HC), nitrogen oxides (NOx), and so forth.

These detrimental substances are generally purified by an exhaust gas purification catalyst in which a catalyst component mainly consisting of a precious metal such as platinum (Pt), rhodium (Rh), palladium (Pd), iridium (Ir), etc., is supported by an oxide support such as alumina.

To support the precious metal of the catalyst component on the oxide support, a method is generally used which involves the steps of using a solution of a precious metal compound, optionally modified, allowing the oxide support to be impregnated with this solution so as to disperse the precious metal compound on the surface of the oxide support, and calcining the oxide support. Materials having a high specific surface area such as gamma-alumina are generally employed for the oxide support to give a large contact area with the catalyst component to the exhaust gas.

It is known that the performance of supported metal catalysts depends on the structure and composition of the metal nanoparticles they contain, and the nature of the support. In particular, conventional impregnation methods used for the preparation of supported catalysts often provide only limited control over the structure of the resulting materials (i.e. average particle size, particle composition and location of the active components).

Higher purification performance of the exhaust gas has been further required for such an exhaust gas purification catalyst in view of exceedingly strict environmental protection regulations. Control of the cluster size of the precious metal to an optimal size is one way of achieving said goal. According to the methods of supporting the precious metal taught in the prior art, a solution of the precious metal compound is used, wherein the precious metal is adsorbed on the oxide support at an atomic level and in which the precious metal compound is dispersed to the surface of the oxide support. A particular disadvantage of said method, however, is that the atoms of the precious metal may migrate and thus spark grain growth during the calcination process, in which the precious metal is fixed. It has therefore been extremely difficult to support only the precious metal of a desired cluster size on the oxide support.

Japanese Unexamined Patent Publication (Kokai) No. 2003-181288 proposes a method for supporting a precious metal on an oxide support by introducing the precious metal into pores of a hollow carbon material such as a carbon nano-horn or a carbon nano-tube so that the precious metal forms a cluster having a desired size, instead of directly supporting the precious metal on the oxide support, fixing the precious metal to the carbon material, then baking them together and thereafter burning and removing the carbon material and at the same time, supporting the precious metal on the oxide support.

According to such a method, the precious metal exists inside the pores of the carbon material until the carbon material is burnt and removed, and when the carbon material is burnt and removed, the precious metal is quickly supported on the oxide support. Therefore, the precious metal can be substantially supported by the oxide support at a cluster size inside the pores of the carbon material. However, this method is not free from problems in which the precious metal must be introduced into the pores of the hollow carbon material, which results in low productivity.

In “Chemical Industry”, pp. 276-296 (1998), Torigoe, Esumi et al. propose to produce precious metal particles having particle sizes in the order of nm by reducing a mixed solution of a polymer compound such as polyvinyl pyrrolidone and precious metal ions by using a reducing agent such as H₂, NaBH₄, C₂H₅OH, or the like.

However, when a compound is used as the reducing agent in the method described above, there is a problem that an element or elements are contained in the compound mix as impurities in the final precious metal particles. When NaBH₄ is used as the reducing agent, for example, Na and B are included. When an alcohol is used as the reducing agent, not only the alcohol, but also ketones, aldehydes, carboxylic acids, etc., formed while the alcohol is oxidised during the reduction of the metal ions, may be included. When hydrogen is used as the reducing agent, problems occur in that the particle diameter of the resulting precious metal particles becomes large and the particles are odd-shaped.

WO 2004/089508 provides a method of preparing an oxidation catalyst for oxidizing volatile organic fraction and a catalyzed wall-flow filter for use in removing soot particulates from diesel engine exhaust, including preparing a platinum group metal salt and a transition/alkali metal salt with a water-soluble polymer compound and a reducing agent, to obtain a first colloidal solution, which is then washcoated to a catalyst-support-coated monolithic ceramic substrate, followed by calcination process at high temperatures, to obtain an oxidation catalyst; and treating a PGM salt and a metal salt mixture including at least one selected from a first group of catalyst metal to increase oxidation activity for nitrogen monoxide (NO) and at least one selected from a second group of catalyst metal to decrease a combustion temperature of soot particulates by oxidizing agents, such as nitrogen dioxide and oxygen, with a water-soluble polymer compound and a reducing agent, to obtain a second colloidal solution, which is then washcoated on a catalyst-support-coated wall-flow filter, followed by calcination process at high temperatures, to obtain a catalyzed wall-flow filter.

WO 95/32790 relates generally to the control of hydrocarbons, carbon monoxide, and nitrogen oxides in the exhaust of internal combustion engines. More particularly, the invention relates to the removal of NO when the exhaust gases include oxygen substantially in excess of that needed for combustion of the fuel. This is for example the case with lean-burn engines, diesel engines, and other engines currently under development.

U.S. 2008/0268159 relates to a production method of a precious metal catalyst. More specifically, the present invention relates to a production method of a precious metal catalyst the cluster size of which is controlled. U.S. 2008/0268159 provides a production method of a precious metal catalyst including the steps of uniformly mixing a solution containing a precious metal and an aqueous solution of a polymer compound capable of coordination with the precious metal to form a complex of the precious metal and the polymer compound, adding the drop-wise aqueous solution containing the complex to water containing micro-bubbles containing therein hydrogen, mixing the solutions to reduce the precious metal, supporting the mixed solution on a support and baking the solution.

U.S. Pat. No. 4,797,380 relates to the production of highly dispersed precious metal catalysts. In particular, the invention relates to the production of precious metal catalysts by means on cross-linking a polymer in a solution to create a polymer film, deposit such polymer film onto the support, impregnating the polymer film with precious metal precursor compounds and finally reducing the precious metal onto the polymer film to obtain the final catalyst onto the polymer film.

The processes known from the state of the art, however, have several disadvantages such as for example the use of elaborate and costly procedures to obtain the final catalyst, in particular when said processes involve the formation of colloidal suspensions. With respect to processes which use colloidal suspensions, a major problem encountered therein regards the limited control over both the colloidal nanoparticle formation and their final location on supporting materials upon impregnation. These disadvantages limit the applicability and feasibility of such methods.

Thus, there is a need to provide a process for preparing a catalyst which does not have the disadvantages of the processes known from the state of the art.

### SUMMARY

One aspect of the present invention relates to a process for the preparation of a catalyst comprising the steps of:
(i) providing one or more support materials;
(ii) providing one or more polymers on the support material; and
(iii) providing one or more metals on the one or more supported polymers;
   wherein in step (ii) the one or more polymers do not comprise cross-linked polymers and/or polymers which have been reacted with a cross-linking agent.

According to one or more embodiments of this aspect, the one or more support materials comprise one or more particulate support materials. In certain embodiments, the one or more support materials provided in step (i) comprise one or more metal oxides.

In one or more embodiments, one or more polymers provided on the support material in step (ii) comprises homo- and/or co-polymers having one or more functional groups capable of coordinating, complexing, and/or binding one or more of the one or more metals provided in step (iii).

According to one embodiment, one or more of the polymers is soluble in a polar solvent. In certain embodiments, one or more polymers provided on the support material in step (ii) comprises one or more of homo- and/or co-polymers of polyvinylalcohols, polyvinylpyrrolidones, polyethyleneimines, polyacrylic acids, and mixtures of two or more thereof. In specific embodiments, one or more polymers has an average molecular weight M_{w} in the range of from 100 to 500,000 g/mol.

Certain embodiments provide the total loading of the one or more support materials with the one or more polymers as obtained in step (ii) is in the range of from 0.1 to 50 wt.-% based on 100 wt.-% of the total amount of the one or more support materials.

In one embodiment of step (ii), the one or more polymers are provided on the support material by impregnation.

According to certain embodiments, one or more metals in step (iii) comprises a transition metal. In specific embodiments of step (iii), the total loading of the one or more support materials with the one or more metals is in the range of from 0.01 to 30 wt.-% based on 100 wt.-% of the total amount of the one or more support materials. According to one or more embodiments of step (iii), the one or more metals are provided on the supported polymers by impregnation.

In one or more embodiments of step (ii), the one or more polymers are provided as a solution of said one or more polymers. In further embodiments, the total concentration of the one or more polymers in the solution ranges from 0.01 to 50%.

According to one or more embodiments, the one of more metals in step (iii) are provided as a solution of said one or more metals.

In certain embodiments of this aspect, the process further comprises a step of (iv) calcining the product of step (iii). Further embodiments provide the calcining is conducted at temperatures in the range of from 450 to 1,500° C.

In one or more embodiments, step (iii) does not include a step of reducing one or more of the one or more metals provided on the one or more supported polymers. Another aspect of the invention pertains to a catalyst obtainable or obtained according to the previously described process.

Yet another aspect provides a treatment system for an automobile exhaust gas stream comprising a combustion engine, and an exhaust gas conduit in fluid communication with the engine, wherein the catalyst described above is provided within the exhaust gas conduit.

Other aspects relate to a method for the treatment of automobile engine exhaust gas comprising:
(a) providing a catalyst according to previously described embodiments; and
(b) conducting an automobile engine exhaust gas stream over and/or through the catalyst, wherein the automobile engine exhaust gas stream is from a lean burn combustion engine. An alternate aspect provides a method for purifying an exhaust gas comprising contacting the exhaust gas with a catalyst according to previously described embodiments.

### DESCRIPTION

It has surprisingly been found that a highly efficient process for the preparation of a catalyst may be provided which avoids the time- and cost-intensive steps of the prior art, in particular regarding the formation of colloidal nanoparticles. Furthermore, it has been unexpectedly been found that a process may be provided which is not only highly efficient, but which avoids many of the disadvantages encountered in the prior art, and in particular those associated with the use of colloidal nanoparticles.

Thus, one aspect of the present invention relates to a process for the preparation of a catalyst comprising the steps of:
(i) providing one or more support materials;
(ii) providing one or more polymers on the support material; and
(iii) providing one or more metals on the one or more supported polymers;
   wherein in step (ii) the one or more polymers do not comprise cross-linked polymers and/or polymers which have been reacted with a cross-linking agent.

It is herewith noted that within the meaning of the present invention, and in particular with respect to specific embodiments thereof, the term “comprising” is preferably used as meaning “consisting of”.

As the support material, any conceivable material may be used, provided that it is capable of supporting both the one or more polymers as well as the one or more metals. According to one or more embodiments of the present invention, it is preferred that the one or more support materials comprise one or more particulate materials. In principle any type of particulate support material may be used, wherein preferably the one or more particulate support materials comprise support particles having an average particle size d₉₀ comprised in the range of from 0.5 to 100, more preferably in the range of from 1 to 50, more preferably from 5 to 30, more preferably from 10 to 20, more preferably from 12 to 18, and wherein even more preferably the support particles have an average particle size d₉₀ ranging from 14 to 16.

As to the type of material used for the one or more support materials, it is preferred that said one or more materials comprise one or metal oxides, preferably one or more metal oxides selected from the group consisting of alumina, silica, ceria, zirconia, titania, magnesia, and mixtures and/or solid solutions of two or more thereof. According to certain embodiments, it is further preferred that the one or more support materials comprise one or more metal oxides selected from the group consisting of alumina, titania, titania-alumina, zirconia, zirconia-alumina, ceria, ceria-alumina, lanthana-alumina, lanthana-zirconia-alumina, titania-zirconia, and mixtures and/or solid solutions of two or more thereof, wherein more preferably the one or more support materials comprise one or more metal oxides selected from the group consisting of alumina, titania-alumina, zirconia-alumina, ceria-alumina, lanthana-alumina, lanthana-zirconia-alumina, and mixtures and/or solid solutions of two or more thereof. According to particularly preferred embodiments of the present invention, the one or more support materials comprise alumina, preferably gamma-alumina.

Regarding the surface area of the one or more support materials used in the process, said support materials may in principle have any conceivable surface area, provided that the one or more polymers and the one or more metals may be provided thereon. According to preferred embodiments, the BET surface area (Brunauer-Emmet-Teller; determined according to DIN 66131 by nitrogen adsorption at 77 K) of one or more of the support materials is comprised in the range of from 50 to 450 m²/g, preferably of from 80 to 350 m²/g, more preferably of from 100 to 300 m²/g, more preferably for from 120 to 250 m²/g, and even more preferably in the range of from 130 to 200 m²/g.

According to this aspect of the present invention, one or more polymers are provided on the one or more support materials in step (ii). In principle, there is no particular limitation as to the type of polymer which may be used, provided that it may be supported on the one or more support materials, and that as such it is then able to support one or metals provided thereon in step (iii). Within the meaning of the present invention, the term “polymer” generally refers to any natural or synthetic macromolecular compound composed of repeating structural units, and preferably to organic polymers. In particular, according to further preferred embodiments, the one or more polymers are selected from the group consisting of homo- and/or co-polymers, and even more preferably from the group consisting of homopolymers.

According to preferred embodiments of the present invention one or more of the one or more polymers are capable of specifically interacting with one or more of the one or more metals provided in step (iii) such that a fixing and/or immobilization of the one or more metals on the one or more polymers may be achieved. In principle, there is no particular limitation according to the present invention with respect to the type of interaction of the one or more polymers with the one or more metals, provided that a certain degree of fixing and/or immobilization of the one or more metals on the one or more supported polymers may be achieved in step (iii). Accordingly, the specific interaction includes any conceivable physical and/or chemical interaction between the metal and the polymer for achieving a fixing and/or immobilization of the metal onto the polymer. Preferably, the specific interaction between the one or more polymers and the one or more metals is achieved by any one of the adsorption, coordination, complexing, binding, and combinations of two or more thereof, of the one or more metals onto the one or more supported polymers in step (iii), including any combination of two or more of said specific types of interaction.

In particular, for achieving the preferred interaction between the one or more of the metals and one or more of the polymers, it is preferred that the one or more polymers contain one or more functional groups capable of coordinating, complexing, and/or binding one or more of the one or more metals provided in step (iii), wherein said binding is preferably achieved by covalent binding, and more preferably by covalent coordinate binding. According to further preferred embodiments, the adsorption, coordination, complexing, and/or binding is achieved by adsorptive interactions between the polymer and the metal, wherein the metal is preferably fixed and/or immobilized by coordinative adsorption on the polymer. According to yet further preferred embodiments, the immobilization and/or fixation is achieved by a combination of covalent coordinate binding and coordinative adsorption.

Thus, according to particularly preferred embodiments, for achieving the fixation and/or coordination of one or more of the metals on one or more of the polymers, said one or more of the polymers comprise one or more functional groups, wherein said one or more functional groups. In principle, any type of functional group may be used, provided that it may be incorporated into the polymer and that it may engage in one or more of any one of the aforementioned interactions with one or more of the metals, and preferably, that it is capable of engaging in adsorptive and/or covalent, preferably covalent coordinate, interactions with one or more of the metals provided in step (iii) of the inventive process. For achieving said interaction, one or more of the functional groups preferably comprised in one or more of the polymers are preferably selected from the group consisting of amino groups, amido groups, carboxylic groups, aldehydic groups, hydroxyl groups, and combinations of two or more thereof, wherein more preferably one or more of the functional groups are selected from the group consisting of amino groups, amido groups, hydroxyl groups, and combinations of two or more thereof. According to particularly preferred embodiments, one or more of the polymers provided in step (ii) have amino and/or amido groups, and even more preferably have amido groups.

Thus, according to preferred embodiments of the inventive process, the one or more polymers provided on the support material in step (ii) are selected from the group consisting of homo-and/or co-polymers having one or more functional groups capable of coordinating, complexing, and/or binding one or more of the one or more metals provided in step (iii), wherein the one or more functional groups are preferably selected from the group consisting of amino groups, amido groups, carboxylic groups, aldehydic groups, hydroxyl groups, and combinations of two or more thereof, more preferably from the group consisting of amino groups, amido groups, hydroxyl groups, and combinations of two or more thereof, wherein more preferably the homo- and/or co-polymers have amino groups and/or amido groups, and even more preferably have amido groups.

Regarding the preferred homo- and/or co-polymers comprised among the one or more polymers provided on the support material in step (ii) of the inventive process there is no particular restriction with respect to the choice thereof, provided that they may be suitably supported in one or more of the support materials and that they are capable of supporting one or more of the metals provided in step (iii), and that they do not comprise cross-linked polymers and/or polymers which have been reacted with a cross-linking agent, wherein said restriction applies to the one or more polymers provided in step (ii). Within the meaning of the present invention, a “cross-linked polymer” generally refers to any polymer, wherein the individual polymer chains are bound to one another by covalent and/or ionic bonds, and preferably wherein the individual polymer chains are bound to one another by covalent bonds, wherein said covalent bonds include both direct covalent bonding between the polymer chains, as well as covalent bonding via a chemical moiety which is covalent bound to the respective chains, thus forming a covalent bridge. According to certain embodiments of the present invention, the term “cross-linked polymer” preferably does not include branched polymers. The term “cross-linking agent” on the other hand refers to any chemical compound which may form a covalent bridge between two or more polymers by engaging in one or more covalent and/or ionic, and preferably one or more covalent bond with each of two or more polymers. By mere way of example, cross-linking agents may for example include sulphur, silanes such as e.g. vinylsilane, glutaraldehyde, glutaric acid, adipic acid, adipyl chloride, 1,6-dibromohexane, hexamethylenediamine, adipamide, and any combination of two or more thereof. Direct covalent cross-linking may by way of example be induced by any conceivable chemical and or physical treatment such as the curing of a polymer to a radiation source such as e.g. electron beam exposure, gamma-radiation, and/or UV-light.

According to one or more embodiments the present invention, it is further preferred that the term “cross-linked polymer” refers to polymers of high average molecular weight M_{w} due to the cross-linking of the individual polymer chains. According to said preferred definition, the present invention does not exclude the use of one or more polymers which are cross-linked, yet which have low average molecular weights M_{w} not typical of a cross-linked polymer. Thus, in a more general sense, the term “cross-linked polymer” refers to any type of polymer which is cross-linked and/or has been treated with a cross-linking agent, and which has an average molecular weight M_{w} of 1,000,000 g/mol or greater, preferably of 500,000 g/mol or greater, more preferably of 200,000 g/mol or greater, more preferably of 100,000 g/mol or greater, and even more preferably of 50,000 g/mol or greater. Thus, according to further preferred embodiments of the present invention, it is not excluded that one or more of the polymers provided in step (ii) of the inventive process includes a certain degree of cross-linking, provided that it has a low average molecular weight compared to typical cross-linked polymers, wherein it preferably has an average molecular weight M_{w} of 500,000 g/mol or less, more preferably of 200,000 g/mol or less, more preferably of 100,000 g/mol or less, more preferably of 50,000 g/mol or less, and even more preferably of 25,000 g/mol or less.

According to particularly preferred embodiments of the present invention, the one or more polymers provided on the support material in step (ii) comprise one or more polymers selected from the group consisting of homo- and/or co-polymers of polyvinylalcohols, polyvinylpyrrolidones, polyethyleneimines, polyacrylic acids, and mixtures of two or more thereof, wherein said one or more polymers are preferably selected from the group consisting of poly(vinylalcohol), poly(vinylpyrrolidone), poly(ethyleneimine), poly(acrylic acid), and mixtures of two or more thereof, and wherein even more preferably, the one or more polymers provided on the support material in step (ii) comprise one or more polymers selected from the group consisting of poly(vinylpyrrolidone), poly(ethyleneimine), poly(acrylic acid), and mixtures of two or more thereof.

It is further preferred that one or more of the polymers provided in step (ii) may be dissolved in a solvent or solvent mixture. In principle the solubility of the polymer in a solvent or solvent mixture is not particularly restricted, neither with respect to the type of solvent or solvent mixture in which it is soluble, nor with respect to the degree to which it is soluble and/or with respect to the maximum concentrations of the solvated polymer which may be achieved by a particular polymer according to the present invention in a specific solvent or solvent mixture. Furthermore, the solubility of one or more of the polymers may be enabled or increased with the aid of a solvating agent which may preferably include one or more surfactants. According to particularly preferred embodiments of the present invention, the one or more polymers which may be dissolved in a solvent or solvent mixture do not require the use of a solvating agent for dissolution therein.

Among the solvents or solvent mixtures in which the one or more of the polymers provided in step (ii) are preferably soluble, it is preferred that the solvents or solvent mixtures comprise one or more solvents selected from the group consisting of polar solvents and mixtures thereof, preferably from the group consisting of ethanol, methanol and water, and mixtures of two or more thereof. According to particularly preferred embodiments, one or more of the polymers provided in step (ii) is soluble in water, and preferably in distilled water, wherein even more preferably, said one or more polymers are soluble in water and preferably in distilled water without the aid of a solvating agent.

With respect to the molecular weight of the one or more polymers provided in step (ii) of the inventive process, any conceivable molecular weight may be employed provided that the polymer may be provided on one or more of the support materials, wherein according to the present invention the terms “molecular weight” and “average molecular weight” with respect to the polymer preferably refer to the weight average molecular weight M_{w} thereof. According to preferred embodiments of the present invention, the average molecular weight M_{w} of one or more of the polymers provided in step (ii) is comprised in the range of from 100 to 500,000, more preferably from 500 to 100,000, more preferably from 1,000 to 50,000, more preferably from 1,500 to 30,000, and even more preferably from 1,800 to 25,000.

According to particularly preferred embodiments of the inventive process comprising one or more homo- and/or copolymers of polyvinylpyrrolidones, and preferably comprising poly(vinylpyrrolidone), the average molecular weight M_{w} thereof preferably ranges from 100 to 100,000 g/mol, more preferably from 500 to 50,000 g/mol, more preferably from 1,000 to 25,000 g/mol, more preferably from 5,000 to 15,000 g/mol, more preferably from 8,000 to 12,000 g/mol, and even more preferably from 9,000 to 11,000 g/mol.

According to other particularly preferred embodiments of the inventive process comprising one or more homo- and/or copolymers of polyethyleneimines, and preferably comprising poly(ethyleneimine), the average molecular weight M_{w} thereof preferably ranges from 100 to 500,000 g/mol, more preferably from 1,000 to 200,000 g/mol, more preferably from 5,000 to 100,000 g/mol, more preferably from 10,000 to 50,000 g/mol, more preferably from 15,000 to 40,000 g/mol, more preferably from 20,000 to 30,000 g/mol, and even more preferably from 24,000 to 26,000 g/mol.

According to yet other particularly preferred embodiments of the inventive process comprising one or more homo- and/or copolymers of polyacrylic acids, and preferably comprising poly(acrylic acid), the average molecular weight M_{w} thereof preferably ranges from 50 to 100,000 g/mol, more preferably from 100 to 50,000 g/mol, more preferably from 500 to 10,000 g/mol, more preferably from 1,000 to 5,000 g/mol, more preferably from 1,500 to 2,500 g/mol, and even more preferably from 1,700 to 1,900 g/mol.

In principle, any conceivable loading of the one or more polymers may be provided on the one or more support materials in step (ii) of the inventive process, wherein it is preferred that the total loading of the one or more support materials with the one or more polymers as obtained in step (ii) is comprised in the range of from 0.1 to 50 wt.-% based on 100 wt.-% of the total amount of the one or more support materials, preferably from 0.5 to 30 wt.-%, more preferably from 0.5 to 30 wt.-%, more preferably from 1 to 20 wt.-%, more preferably from 5 to 15 wt.-%, more preferably from 8 to 12 wt.-%, and even more preferably from 9 to 11 wt.-%.

Any conceivable method may be chosen for providing the one or more polymers on the one or more support materials in step (ii). According to a preferred embodiment, the one or more polymers are provided in the support material by impregnation. Within the meaning of the present invention, the term “impregnation” refers to any suitable process by which the one or more polymers provided in step (ii) may be evenly distributed on the entire surface of the one or more support materials, wherein the entire surface refers to those portions of the one or more support materials which may be readily accessed by the one or more polymers, wherein the accessibility of said surface may depend on the size of the one or more polymers, as well as on the specific impregnation method employed. The impregnation techniques which may be employed to this effect may be any wet or dry impregnation methods, wherein wet impregnation methods are particularly preferred.

Thus, for achieving the impregnation of the one or more support materials in step (ii), it is particularly preferred according to the present invention that the one more polymers are provided as a solution of said of said one or more polymers. In general, any conceivable solution using any possible solvent or any possible combination of two or more solvents may be used. Furthermore, there is no particular restriction as to the concentration of the one or more polymers in the solution used, provided that the one or more polymers may be effectively provided on the one or more support materials.

According to preferred embodiments of the inventive process, the solution comprises one or more solvents selected from the group consisting of polar solvents and mixtures thereof. In general, any polar solvent may be used including protic and aprotic solvents as well as combinations thereof, wherein solvents or solvent mixtures are preferably used which comprise one or more protic solvents. Thus, according to particularly preferred embodiments of the inventive process, the one or more polymers are provided in step (ii) as a solution, wherein the solvent comprises one or more solvents selected from the group consisting of ethanol, methanol and water, and mixtures of two or more thereof, wherein more preferably the solution comprises water, and wherein even more preferably the solvent comprises distilled water. Furthermore, it is preferred that the total concentration of the one or more polymers in the solution preferably used in step (ii) ranges from 0.01 to 50%, wherein the total concentration preferably ranges from 0.05 to 30%, more preferably from 0.1 to 20%, more preferably from 0.5 to 15%, and even more preferably from 1 to 5%.

Prior to step (iii), the one or more support materials loaded with the one or more polymers as obtained in step (ii) may be suitably separated from a mixture of a solution and said loaded support materials in instances wherein a wet impregnation process has been preferably used. In general, there is no particular restriction as to the separation method employed for isolating the solid product of step (ii). The solid product may for example be separated by any one or more of a filtration, centrifugation, decantation, and evaporation process, wherein it is preferred to separate the polymer loaded support material by a filtration and/or an evaporation process, and wherein even more preferably, the polymer loaded support material is separated by an evaporation process.

Furthermore, in instances in which the polymer loaded support material obtained in step (ii) is not entirely free from a solvent or solvent mixture used in step (ii) such as after the separation thereof from a solvent or solvent mixture in which it is contained, the polymer loaded support material may be further subject to a drying process prior to being employed in step (iii). In principle, any conceivable drying process may be used for any suitable duration, provided that the dried product is then suitable for supporting one or more metals subsequently provided in step (iii). According to preferred embodiments, the polymer loaded support material may for example be dried at a temperature ranging from 50 to 150° C., and is preferably dried at a temperature ranging from 60 to 140° C., more preferably from 80 to 120° C., more preferably from 90 to 110° C., and even more preferably from 95 to 105° C. Furthermore, the drying process may for example be conducted for a duration anywhere from 0.1 to 12 h, wherein a duration of from 0.5 to 8 h is preferred, more preferably of from 1 to 4 h, and even more preferably of from 1.5 to 2.5 h.

Therefore, according to preferred embodiments of the present invention, the one or more polymers are provided in step (ii) of the inventive process as a solution of said of said one or more polymers, wherein the solution preferably comprises one or more solvents selected from the group consisting of polar solvents and mixtures thereof, preferably from the group consisting of ethanol, methanol and water, and mixtures of two or more thereof, wherein even more preferably the solution comprises water, preferably distilled water, wherein the solid product obtained in step (ii) is then preferably separated from the solution and/or dried, more preferably separated from the solution and subsequently dried.

In step (iii), one or more metals are provided on the one or more polymers supported on the one or more support materials obtained in step (ii). In principle, any conceivable metal may be provided on the polymer loaded support material, wherein it is preferred that the one or more metals comprise one or more catalytically active metals. Within the meaning of the present invention, the term “catalytically active metal” refers to any metal which may effectively catalyze a chemical reaction, wherein said term preferably refers to metals which are active in heterogeneous catalysis, wherein the metal is present in the solid stated, and the chemical reaction takes place in the liquid or gas phase. According to embodiments of the present invention, it is particularly preferred that the term “catalytically active metal” refers to a metal which is active in heterogeneous catalysis, wherein the metal is present in the solid phase, and the chemical reaction, and more specifically the chemical reactants of said reaction are present and/or provided in the gas phase.

According to preferred embodiments, the one or more metals in step (iii) are selected from the group consisting of transition metals, preferably from the group of transition metals which are catalytically active transition metals within the meaning of the present invention. In particular, it is preferred that the one or more metals provided in step (iii) comprise one or more metals selected from the group consisting of V, Cr, Mn, Fe, Co, Ni, Cu, Zn, Ru, Rh, Pd, Ag, Pt, Au, and combinations of two or more thereof, and more preferably from the group consisting of Fe, Co, Ni, Cu, Rh, Pd, Ag, Pt, Au, and combinations of two or more thereof, more preferably from the group consisting of Rh, Pd, Pt, Au, Ag, and combinations of two or more thereof, more preferably from the group consisting of Rh, Pd, Pt, and combinations of two or more thereof, and wherein even more preferably the one or more metals in step (iii) comprise Pt and/or Pd. According to particularly preferred embodiments of the present invention, the one or more metals provided in step (iii) comprise both Pt and Pd.

In general, there is no particular restriction as to the amount of the one or more metals provided on the polymer loaded support material in step (iii). Thus, by way of example, the total loading of the polymer loaded support materials with the one or more metals may range anywhere from 0.01 to 30 wt.-% based on 100 wt.-% of the total amount of the one or more support materials, wherein it is preferred that the total loading of the one or more metals based on the support material ranges from 0.05 to 20 wt.-%, more preferably from 0.1 to 10 wt.-%, more preferably from 1 to 5 wt.-%, more preferably from 3 to 4 wt.-%, more preferably from 3.25 to 3,75 wt.-%, and even more preferably from 3.45 to 3.55 wt.-%.

As to the method for providing the one or more metals on the polymer loaded support material in step (iii), there is no particular restriction in the respect, provided that the one or more metals may be suitably supported thereon. According to preferred embodiments, the one or more metals are provided on the one or more polymers supported on the one or more support materials obtained from step (ii) by an impregnation method, and preferably by a wet impregnation process. It is, however, particularly preferred that the one or more metals are provided in the polymer loaded support material by an incipient wetness technique.

In step (iii), the one or more metals may be provided in any suitable form, provided that they may be provided on the polymer loaded support material. According to preferred embodiments of the present invention, and in particular according to preferred embodiments wherein the one or more metals are provided on the polymer loaded support material by a wet impregnation process and even more preferably by an incipient wetness technique, the one or more metals are provided in a soluble form and in particular in a form in which they may be suitably dissolved in a solvent or solvent mixture employed in a wet impregnation method. According to particularly preferred embodiments, the one or more metals are provided as respective salts, preferably as their respective salts which allows their dissolution in a solvent or solvent mixture in a desired concentration, and more preferably as respective salts which allows for their dissolution in solvents or solvent mixtures comprising polar solvents, preferably protic and/or aprotic solvents, more preferably protic solvents, and more preferably solvent or solvent mixtures comprising one or more solvents selected from the group consisting of ethanol, methanol and water, and mixtures of two or more thereof, and even more preferably as their respective water soluble salts.

According to the preferred embodiments of the inventive process wherein the one or more metals are provided by wet impregnation, and more preferably by incipient wetness, on the polymer loaded support materials, any conceivable solvent or mixture of solvents may be used to this effect, provided that the one or more metals may be suitably provided on the polymer loaded support material. According to embodiments which are further preferred, the solvent or mixture of two or more solvents employed for the preferred wet impregnation in step (iii) are selected from the group of polar solvents and mixtures thereof. In general, any polar solvent may be used including protic and aprotic solvents as well as combinations thereof, wherein solvents or solvent mixtures are preferably used which comprise one or more protic solvents. Thus, according to particularly preferred embodiments of the inventive process, the one or more metals are provided in step (iii) as a solution, wherein the solvent comprises one or more solvents selected from the group consisting of ethanol, methanol and water, and mixtures of two or more thereof, wherein more preferably the solution comprises water, and wherein even more preferably the solvent comprises distilled water. Furthermore, regarding the concentration of the one or more metal in the solvent or mixture of solvents preferably used, any suitable concentration may be used provided that the desired loading of the metal loaded support material obtained in step (iii) is achieved, and preferably the loading with one or more metals according to the preferred and particularly preferred embodiments of the present invention is achieved.

After having provided the one or more metals on the polymer loaded support material according to step (iii), said metal loaded product may be subject to any further suitable treatment steps for obtaining the final catalyst according to the present invention. In particular, the metal loaded product obtained in step (iii) may be subject to a step of separation from a solvent or solvent mixture preferably used in step (iii). To this effect, any suitable separation method may be employed for isolating the solid product of step (iii), such as for example filtration, centrifugation, decantation, and/or evaporation of the solvent or solvent mixture, wherein it is preferred to separate the metal loaded support material by a filtration process.

According to particularly preferred embodiments of the inventive process, and in particular according to embodiments employing an impregnation method of the one or more metals by incipient wetness in step (iii), it is preferred to separate the metal loaded product from the solvent or solvent mixture used therein by evaporation of said solvent or solvent mixture.

Furthermore, metal loaded support material obtained in step (iii) may be further subject to a drying process, wherein in principle any conceivable drying process may be used for any suitable duration. Thus, by way of example, the metal loaded support material obtained in step (iii), and preferably the metal loaded support material which has been suitably separated from one or more solvents preferably employed in step (iii), may be subsequently dried at a temperature ranging anywhere from 50 to 250° C., wherein it is preferred to dry the metal loaded material obtained in step (iii) at a temperature ranging from 60 to 200° C., more preferably from 80 to 160° C., more preferably from 100 to 140° C., more preferably from 110 to 130° C., and even more preferably from 115 to 125° C. Furthermore, the preferred drying treatment may be performed for any suitable duration such as for anywhere from 1 to 48 h, wherein drying is preferably performed for a duration of from 2 to 36 h, more preferably of from 4 to 24 h, more preferably of from 6 to 20 h, more preferably of from 8 to 16 h, and even more preferably of from 10 to 14 h.

Thus, according to preferred embodiments of the inventive process, the one of more metals are provided in step (iii) as a solution of said one or more metals, wherein the solution preferably comprises one or more solvents selected from the group consisting of polar solvents and mixtures thereof, preferably from the group consisting of ethanol, methanol and water, and mixtures of two or more thereof, wherein even more preferably the solution comprises water, preferably distilled water, wherein the solid product obtained in step (iii) is preferably separated from the solution and/or dried, more preferably separated from the solution and subsequently dried.

Furthermore, according to further preferred embodiments of the inventive process wherein a separation step is performed, said separation is performed in step (ii) and/or (iii), and preferably in steps (ii) and (iii), wherein the separation is preferably achieved by filtration and/or evaporation of the solvent, more preferably by evaporation, and wherein even more preferably the separation in steps (ii) and (iii) is achieved by evaporation.

In addition to this, according to yet further preferred embodiments of the inventive process wherein a drying step is performed, said drying step is performed in step (ii) and/or (iii), and preferably in steps (ii) and (iii), wherein said drying step is conducted at temperatures comprised in the range of from 50 to 250° C., preferably of from 50 to 200° C., more preferably from 70 to 150° C., more preferably from 80 to 140° C., more preferably from 90 to 130° C., and even more preferably from 100 to 120 ° C.

According to particularly preferred embodiments wherein the loading of the polymer loaded support materials in step (iii) is achieved by an incipient wetness technique, the steps of separation and drying of the metal loaded material obtained therein is preferably achieved by a single drying step, and in particular by a drying step according to preferred and particularly preferred embodiments of the present invention.

According to the one or more embodiments, it is further preferred that the inventive process comprises a further step (iv) of calcining the product obtained in step (iii). In principle, there is no particular restriction as to the temperature used for the preferred calcinations step, nor with respect to the duration thereof. Thus, by way of example, the calcination may be performed at a temperature ranging anywhere from 450 to 1,500° C., wherein it preferred that the calcinations be performed at a temperature comprised in the range of from 500 to 1,200° C., more preferably from 600 to 1,000° C., more preferably from 700 to 900° C., and even more preferably from 750 to 850° C. Furthermore, by way of example, the calcination may suitably be performed for a duration of from 1 to 48 h, wherein calcination is preferably performed for a duration of from 2 to 36 h, more preferably of from 4 to 24 h, more preferably of from 6 to 20 h, more preferably of from 8 to 16 h, more preferably from 10 to 14 h and even more preferably of from 11 to 13 h.

Regarding the atmosphere under which the calcination step is performed, any suitable atmosphere may be chosen depending on the type of the one or more support materials, the type of the one or more polymers, and more importantly the type of the one or more metals supported on the former in addition to the use for which the catalyst is intended. Thus, the calcinations may be performed under any one of an inert atmosphere, an oxidizing atmosphere, and a reducing atmosphere, wherein according to the present invention the calcination step is preferably performed under air. According to preferred embodiments of the present invention wherein the calcination is performed under air, it is further preferred that the water content thereof is comprised in the range of from 1 to 80 wt.-%, more preferably from 2 to 50 wt.-%, more preferably from 5 to 40 wt.-%, more preferably from 6 to 30 wt.-%, more preferably from 7 to 20 wt.-%, more preferably from 8 to 15 wt.-%, and even more preferably from 9 to 11 wt.-%.

In general, any further treatments may be suitably included in addition to the aforementioned treatment procedures according to the embodiments and preferred embodiments of the present invention provided that a catalyst may be provided by the inventive process having one or more metals loaded on one or more support materials. According to preferred embodiments of the present invention, however, the one or more procedures performed in step (iii) does not include a step of reducing one or more of the one or more metals provided on the one or more supported polymers, and wherein it is further preferred that the one or more procedures performed in step (iii) up to and preferably including step (iv) does not include a step of reducing one or more of the one or more metals provided on the one or more support materials. Within the meaning of the present invention, a step of reducing one or more of the one or more metals refers to any chemical or physical process which is actively performed on one or more of the metals, and as a result of which the oxidation state thereof is reduced by one or more integers. Within a preferred meaning of the present invention, a step of reducing one or more of the one or more metals refers to a step of adding one or more chemical substances in addition to and not including the substances provided in step (iii) according to the embodiments and preferred embodiments of the present invention and/or directly or indirectly subjecting one or more of the one or more metals to an electrochemical treatment, wherein said one or more additional chemical substances engage in a redox reaction with one or more of the metals and/or wherein the electrochemical treatment leads to a change in the oxidation state of one or more of the metals, as a result of which the oxidation state of one or more of the metals is reduced by one or more integers.

Another aspect of present invention relates to a catalyst which may be obtained according to the previously described process, or which is obtainable by this process, and in particular by any one of the aforementioned embodiments and preferred embodiments thereof.

In addition to the above-mentioned process for the preparation of a catalyst, and to the catalyst which is obtained or obtainable according to the process, another aspect of the present invention is directed to treatment systems for an automobile exhaust gas stream. In particular, the treatment system according to this aspect comprises a combustion engine, preferably a diesel engine, an exhaust gas conduit in fluid communication with the engine, and a catalyst obtained or obtainable as described herein which is provided within the exhaust gas conduit. In principle, any conceivable combustion engine may be used in the treatment system of the present invention, wherein preferably a lean burn engine is used such as a diesel engine or a lean burn gasoline engine, more preferably a diesel engine.

Thus, according to a preferred embodiment of the present invention, the catalyst is comprised in a treatment system for an automobile exhaust gas stream comprising:
a combustion engine, preferably a diesel engine or a lean burn gasoline engine, more preferably a diesel engine, and
an exhaust gas conduit in fluid communication with the engine, wherein the catalyst is provided within the exhaust gas conduit.

In addition to these aspects, also provided is a method for the treatment of automobile engine exhaust gas using the catalyst which is obtained or obtainable according to the previously described process. More specifically, the method of this aspect includes conducting an automobile engine exhaust gas over and/or through the catalyst, wherein the automobile engine exhaust gas is preferably one which is generated by a lean burn combustion engine, and preferably by a diesel engine of lean burn gasoline engine, wherein even more preferably the exhaust gas is one which is generated by a diesel engine.

Thus, embodiments of this aspect of the present invention also relate to a method for the treatment of automobile engine exhaust gas comprising:
(a) providing a catalyst which is obtained or obtainable according to the inventive process for the preparation of a catalyst; and
(b) conducting an automobile engine exhaust gas stream over and/or through the catalyst;
   wherein the automobile engine exhaust gas stream is from a lean burn combustion engine, preferably from a diesel engine or a lean burn gasoline engine, and even more preferably a diesel engine.

Regarding the catalyst which is obtained or obtainable according to the process for the preparation of a catalyst, there is no particular restriction as to the application in which it may be used. It is, however, preferred according to certain embodiments of the present invention that said catalyst is used for the purification of flue gas or exhaust gas, and more preferably for the purification of exhaust gas from an internal combustion engine, more preferably from a lean burn combustion engine, more preferably from a diesel engine or a lean burn gasoline engine, more preferably a diesel engine, wherein even more preferably the catalyst is used as a diesel oxidation catalyst.

The present invention includes the following embodiments, wherein these include the specific combinations of embodiments as indicated by the respective interdependencies defined therein:

1. A process for the preparation of a catalyst comprising the steps of:
(i) providing one or more support materials;
(ii) providing one or more polymers on the support material; and
(iii) providing one or more metals on the one or more supported polymers; wherein in step (ii) the one or more polymers do not comprise cross-linked polymers and/or polymers which have been reacted with a cross-linking agent.

2. The process of embodiment 1, wherein the one or more support materials comprise one or more particulate support materials, preferably one or more particulate support materials having an average particle size d₉₀ in the range of from 0.5 to 100, more preferably from 1 to 50, more preferably from 5 to 30, more preferably from 10 to 20, more preferably from 12 to 18, and even more preferably from 14 to 16.

3. The process of embodiment 1 or 2, wherein the one or more support materials provided in step (i) comprise one or more metal oxides, preferably one or more metal oxides selected from the group consisting of alumina, silica, ceria, zirconia, titania, magnesia, and mixtures and/or solid solutions of two or more thereof,

more preferably from the group consisting of alumina, titania, titania-alumina, zirconia, zirconia-alumina, ceria, ceria-alumina, lanthana-alumina, lanthana-zirconia-alumina, titania-zirconia, and mixtures and/or solid solutions of two or more thereof,
more preferably from the group consisting of alumina, titania-alumina, zirconia-alumina, ceria-alumina, lanthana-alumina, lanthana-zirconia-alumina, and mixtures and/or solid solutions of two or more thereof,
and wherein even more preferably the one or more support materials comprise alumina, preferably gamma-alumina.

4. The process of any of embodiments 1 to 3, wherein the one or more polymers provided on the support material in step (ii) is selected from the group consisting of homo- and/or co-polymers having one or more functional groups capable of coordinating, complexing, and/or binding one or more of the one or more metals provided in step (iii),

wherein the one or more functional groups are preferably selected from the group consisting of amino groups, amido groups, carboxylic groups, aldehydic groups, hydroxyl groups, and combinations of two or more thereof,
more preferably from the group consisting of amino groups, amido groups, hydroxyl groups, and combinations of two or more thereof,
wherein more preferably the homo- and/or co-polymers have amino groups and/or amido groups, and even more preferably have amido groups.

5. The process of any of embodiments 1 to 4, wherein one or more of the one or more polymers is soluble in one or more solvents selected from the group consisting of polar solvents and mixtures thereof, preferably from the group consisting of ethanol, methanol and water, and mixtures of two or more thereof, wherein even more preferably one or more of the one or more polymers is soluble in water, preferably in distilled water.

6. The process of any of embodiments 1 to 5, wherein the one or more polymers provided on the support material in step (ii) comprise one or more polymers selected from the group consisting of homo- and/or co-polymers of polyvinylalcohols, polyvinylpyrrolidones, polyethyleneimines, polyacrylic acids, and mixtures of two or more thereof,

more preferably from the group consisting of poly(vinylalcohol), poly(vinylpyrrolidone), poly(ethyleneimine), poly(acrylic acid), and mixtures of two or more thereof, and even more preferably from the group consisting of poly(vinylpyrrolidone), poly(ethyleneimine), poly(acrylic acid), and mixtures of two or more thereof.

7. The process of any of embodiments 1 to 6, wherein the one or more polymers comprise one or more polymers having an average molecular weight M_{w} comprised in the range of from 100 to 500,000 g/mol, preferably from 500 to 100,000 g/mol, more preferably from 1,000 to 50,000 g/mol, more preferably from 1,500 to 30,000 g/mol, and even more preferably from 1,800 to 25,000 g/mol.

8. The process of any of embodiments 1 to 7, wherein the total loading of the one or more support materials with the one or more polymers as obtained in step (ii) is comprised in the range of from 0.1 to 50 wt.-% based on 100 wt.-% of the total amount of the one or more support materials, preferably from 0.5 to 30 wt.-%, more preferably from 0.5 to 30 wt.-%, more preferably from 1 to 20 wt.-%, more preferably from 5 to 15 wt.-%, more preferably from 8 to 12 wt.-%, and even more preferably from 9 to 11 wt.-%.

9. The process of any of embodiments 1 to 8, wherein in step (ii) the one or more polymers are provided on the support material by impregnation.

10. The process of any of embodiments 1 to 9, wherein the one or more metals in step (iii) are selected from the group consisting of transition metals, preferably from the group consisting of V, Cr, Mn, Fe, Co, Ni, Cu, Zn, Ru, Rh, Pd, Ag, Pt, Au, and combinations of two or more thereof,

more preferably from the group consisting of Fe, Co, Ni, Cu, Rh, Pd, Ag, Pt, Au, and combinations of two or more thereof,
more preferably from the group consisting of Rh, Pd, Pt, Au, Ag, and combinations of two or more thereof,
more preferably from the group consisting of Rh, Pd, Pt, and combinations of two or more thereof, and
wherein even more preferably the one or more metals in step (iii) comprise Pt and/or Pd, preferably Pt and Pd.

11. The process of any of embodiments 1 to 10, wherein in step (iii) the total loading of the one or more support materials with the one or more metals is comprised in the range of from 0.01 to 30 wt.-% based on 100 wt.-% of the total amount of the one or more support materials, preferably from 0.05 to 20 wt.-%, more preferably from 0.1 to 10 wt.-%, more preferably from 1 to 5 wt.-%, more preferably from 3 to 4 wt.-%, more preferably from 3.25 to 3,75 wt.-%, and even more preferably from 3.45 to 3.55 wt.-%.

12. The process of any of embodiments 1 to 11, wherein in step (iii) the one or more metals are provided on the supported polymers by impregnation, preferably by incipient wetness.

13. The process of any of embodiments 1 to 12, wherein in step (ii) the one or more polymers are provided as a solution of said of said one or more polymers, wherein the solution preferably comprises one or more solvents selected from the group consisting of polar solvents and mixtures thereof, preferably from the group consisting of ethanol, methanol and water, and mixtures of two or more thereof, wherein even more preferably the solution comprises water, preferably distilled water,

wherein the solid product obtained in step (ii) is preferably separated from the solution and/or dried, more preferably separated from the solution and subsequently dried.

14. The process of embodiment 13, wherein the total concentration of the one or more polymers in the solution ranges from 0.01 to 50%, preferably from 0.05 to 30%, more preferably from 0.1 to 20%, more preferably from 0.5 to 15%, and even more preferably from 1 to 5%.

15. The process of any of embodiments 1 to 14, wherein the one of more metals in step (iii) are provided as a solution of said one or more metals, wherein the solution preferably comprises one or more solvents selected from the group consisting of polar solvents and mixtures thereof, preferably from the group consisting of ethanol, methanol and water, and mixtures of two or more thereof, wherein even more preferably the solution comprises water, preferably distilled water,

wherein the solid product obtained in step (iii) is preferably separated from the solution and/or dried, more preferably separated from the solution and subsequently dried.

16. The process of any of embodiments 13 to 15, wherein the separation in step (ii) and/or (iii), preferably in steps (ii) and (iii), is achieved by filtration and/or evaporation of the solvent, wherein even more preferably the separation in steps (ii) and/or (iii), preferably in steps (ii) and (iii) is achieved by evaporation.

17. The process of any of embodiments 13 to 16, wherein drying in step (ii) and/or (iii), preferably in steps (ii) and (iii), is conducted at temperatures comprised in the range of from 50 to 200° C., preferably from 70 to 150° C., more preferably from 80 to 140° C., more preferably from 90 to 130° C., and even more preferably from 100 to 120° C.

18. The process of any of embodiments 1 to 17, wherein the process further comprises a step of:
(iv) calcining the product of step (iii).

19. The process of embodiment 18, wherein calcining is conducted at temperatures comprised in the range of from 450 to 1,500° C., preferably from 500 to 1,200° C., more preferably from 600 to 1,000° C., more preferably from 700 to 900° C., and even more preferably from 750 to 850° C.

20. The process of any of embodiments 1 to 19 wherein step (iii) does not include a step of reducing one or more of the one or more metals provided on the one or more supported polymers, wherein preferably the process up to and including step (iv) does not include a step of reducing one or more of the one or more metals provided on the one or more support materials.

21. A catalyst obtainable or obtained according to any one of embodiments 1 to 20.

22. The catalyst of embodiment 21, wherein the catalyst is comprised in a treatment system for an automobile exhaust gas stream comprising:
a combustion engine, preferably a diesel engine or a lean burn gasoline engine, more preferably a diesel engine, and
an exhaust gas conduit in fluid communication with the engine, and wherein the catalyst is provided within the exhaust gas conduit.

23. A method for the treatment of automobile engine exhaust gas comprising:
(a) providing a catalyst according to embodiment 21 or 22; and
(b) conducting an automobile engine exhaust gas stream over and/or through the catalyst;
   wherein the automobile engine exhaust gas stream is from a lean burn combustion engine, preferably from a diesel engine or a lean burn gasoline engine, and even more preferably a diesel engine.

24. Use of a catalyst according to embodiment 21 or 22 as an exhaust gas purification catalyst, preferably as a catalyst for the purification of exhaust gas from a lean burn combustion engine, more preferably from a diesel engine or a lean burn gasoline engine, more preferably a diesel engine, wherein even more preferably the catalyst is used as a diesel oxidation catalyst.

### EXAMPLES

### Example 1

20g of alumina powder with a BET surface area of 150 m²/g and an average particle size d₉₀ of 15 pm were impregnated with an aqueous solution containing 1 wt.-% of poly(vinylpyrrolidone) (PVP) having an average molecular weight M_{w}=10,000 g/mol, thus achieving a loading of the alumina with PVP of 10 wt.-% based on the weight of the alumina.

The solution was then filtered to remove the excess water, and the PVP coated alumina particles were subsequently dried at 100° C. and stirring for 2 h. Pt and Rh were then loaded onto the PVP coated particles by incipient wetness using a solution thereof to achieve a loading of 2.33 wt.-% of Pt and 1.16 wt.-% of Pd based on the weight of the alumina. The impregnated material was then dried overnight at 120° C.

### Example 2

The same procedure as for Example 1 was repeated using poly(acrylic acid) (PAA) as the polymer, wherein the PAA had an average molecular weight M_{w}=1,800 g/mol.

### Example 3

The same procedure as for Example 1 was repeated using poly(ethyleneimine) (PEI) as the polymer, wherein the PEI had an average molecular weight M_{w}=25,000 g/mol.

### Comparative Example 1

20g of alumina powder with a BET surface area of 150 m²/g and an average particle size d₉₀ of 15 μm were impregnated with Pt and Rh by incipient wetness using a solution thereof to achieve a loading of 2.33 wt.-% of Pt and 1.16 wt.-% of Pd based on the weight of the alumina. The impregnated material was then dried overnight at 120° C.

### Oxidation Performance Testing

The gas activity of the impregnated materials obtained according to the foregoing examples and comparative examples were tested in a laboratory reactor simulating the exhaust emissions of a conventional diesel engine. The reaction conditions used were a fixed bed tube reactor where 40 mg of powder were diluted with 100 mg of cordierite material and the mixture was crushed and sieved in the range of 250-500 micrometer. The total gas flow rate was 200 ml/min and the resulting space velocity was equivalent to 15,000-20,000 per hour that would be experienced by a monolith sample. The gas composition used in the powder reactor testing comprised 2000 ppm CO, 100 ppm NO, 300 ppm C₃H₆, 300 ppm C₃H₈, 350 ppm toluene, 12% O₂, and 5% H₂O, wherein the hydrocarbon (HC) concentrations are reported on a C1 basis.

At the beginning of the light-off test, the powder sample was equilibrated in the gas mixture for 20 minutes at 50° C. The temperature at which 50% conversion was observed is denoted as T₅₀ and was used as the measure of catalyst activity: the lower the T₅₀, the better the catalyst performance. The activity after thermal aging for 12 h at 800° C. of the samples prepared according to the process of the invention as outlined in Example 1, Example 2, and Example 3 was then compared to that of sample prepared according to Comparative Example 1. The results are displayed below in Table 1.

TABLE 1

| Sample | CO T₅₀ |
|---|---|
| Example 1 (PVP) | 150 |
| Example 2 (PAA) | 154 |
| Example 3 (PEI) | 156 |
| Comparative Example 1 | 164 |

Thus, as may be taken from the results in Table 1 from comparative testing performed on the samples from the examples and comparative examples, the catalytic activity of the samples prepared according to the process of invention is noticeably higher than that of the samples prepared according to Comparative Example 1 as indicated by the lower T₅₀ value for the oxidation of CO in the feed stream used for the evaluation.

1. A process for the preparation of a catalyst comprising the steps of:
(i) providing one or more support materials;
(ii) providing one or more polymers on the support material; and
(iii) providing one or more metals on the one or more supported polymers;
wherein in step (ii) the one or more polymers do not comprise cross-linked polymers and/or polymers which have been reacted with a cross-linking agent.

2. The process of claim 1, wherein the one or more support materials comprise one or more particulate support materials.

3. The process of claim 1, wherein the one or more support materials provided in step (i) comprise one or more metal oxides.

4. The process of claim 1, wherein one or more polymers provided on the support material in step (ii) comprises homo- and/or co-polymers having one or more functional groups capable of coordinating, complexing, and/or binding one or more of the one or more metals provided in step (iii).

5. The process of claim 1, wherein one or more polymers is soluble in a polar solvent.

6. The process of claim 1, wherein one or more polymers provided on the support material in step (ii) comprises one or more of homo- and/or co-polymers of polyvinylalcohols, polyvinylpyrrolidones, polyethyleneimines, polyacrylic acids, and mixtures of two or more thereof.

7. The process of claim 1, wherein one or more polymers has an average molecular weight M_{w} in the range of from 100 to 500,000 g/mol.

8. The process of claim 1, wherein the total loading of the one or more support materials with the one or more polymers as obtained in step (ii) is in the range of from 0.1 to 50 wt.-% based on 100 wt.-% of the total amount of the one or more support materials.

9. The process of claim 1, wherein in step (ii) the one or more polymers are provided on the support material by impregnation.

10. The process of claim 1, wherein one or more metals in step (iii) comprises a transition metal.

11. The process of claim 1, wherein in step (iii) the total loading of the one or more support materials with the one or more metals is in the range of from 0.01 to 30 wt.-% based on 100 wt.-% of the total amount of the one or more support materials.

12. The process of claim 1, wherein in step (iii) the one or more metals are provided on the supported polymers by impregnation.

13. The process of claim 1, wherein in step (ii) the one or more polymers are provided as a solution of said one or more polymers.

14. The process of claim 13, wherein the total concentration of the one or more polymers in the solution ranges from 0.01 to 50%.

15. The process of claim 1, wherein the one of more metals in step (iii) are provided as a solution of said one or more metals.

16. The process of claim 1, wherein the process further comprises a step of:
(iv) calcining the product of step (iii).

17. The process of claim 16, wherein calcining is conducted at temperatures in the range of from 450 to 1,500° C.

18. The process of claim 1, wherein step (iii) does not include a step of reducing one or more of the one or more metals provided on the one or more supported polymers.

19. A catalyst obtainable or obtained according to claim 1.

20. A treatment system for an automobile exhaust gas stream comprising:
a combustion engine, and
an exhaust gas conduit in fluid communication with the engine, wherein the catalyst of claim 19 is provided within the exhaust gas conduit.

21. A method for the treatment of automobile engine exhaust gas comprising:
(a) providing a catalyst according to claim 19; and
(b) conducting an automobile engine exhaust gas stream over and/or through the catalyst;
wherein the automobile engine exhaust gas stream is from a lean burn combustion engine.

22. A method for purifying an exhaust gas comprising contacting the exhaust gas with a catalyst according to claim 19.
